(19) United States
(12) Patent Application Publication
(10) Pub. No.: US 2022/0177199 A1
(43) Pub. Date: Jun. 9, 2022

(54) MULTIPLE ASYMMETRIC ANCHOR CONTAINER CLOSURE

(71) Applicant: Niagara Bottling, LLC, Diamond Bar, CA (US)

(72) Inventors: Naser Imran Hossain, Diamond Bar, CA (US); Mohammad Adom Safiullah, Diamond Bar, CA (US); Sean Daley, Diamond Bar, CA (US)

(73) Assignee: Niagara Bottling, LLC, Diamond Bar, CA (US)

(21) Appl. No.: 17/112,681

(22) Filed: Dec. 4, 2020

(51) Int. Cl. B65D 41/34; B67B 3/20

(52) U.S. Cl. CPC B65D 41/3428; B67B 3/20

(57) ABSTRACT

An apparatus and methods are provided for a container closure for sealing contents within an interior of a container. The container closure comprises a closure portion coupled to a tamper evidence band by a plurality of anchors. The closure portion threadably engages a finish portion of the container and seals contents in the interior of the container. The anchors keep the tamper evidence band coupled with the closure portion. Multiple thin connections are arranged at various intervals around the circumference of the tamper evidence band and between adjacent anchors. The thin connections break apart when the closure portion is untightened from the finish portion, providing an observational indication that the container closure has been unsealed from the finish portion after having been installed by a manufacturer. The anchors remain unbroken and cause the tamper evidence band to remain attached to the closure portion upon being removed from the finish portion.

### FIELD

Embodiments of the present disclosure generally relate to the field of plastic bottles and preforms. More specifically, embodiments of the present disclosure relate to an apparatus and methods for a container closure that includes multiple anchors for keeping a tamper evidence band coupled with the container closure after having been unsealed to access contents within a container.

### BACKGROUND

Plastic containers have been used as a replacement for glass or metal containers in the packaging of beverages for several decades. The most common plastic used in making beverage containers today is polyethylene terephthalate (PET). Containers made of PET are transparent, thin walled, and have the ability to maintain their shape by withstanding the force exerted on the walls of the container by their contents. Advantages of PET containers include lighter weight and decreased breakage as compared to glass, and lower costs overall when taking both production and transportation into account. PET resins are also reasonably priced and easy to process. PET containers are generally made by a process that includes the blow-molding of plastic preforms which have been made by injection molding of the PET resin.

Advantages of plastic containers include lighter weight and decreased breakage as compared to glass, and lower costs overall when taking both production and transportation into account. As such, there is a continuous interest in creating the lightest possible plastic container so as to maximize cost savings in both transportation and manufacturing by making and using containers that contain less plastic.

A PET container for storing liquid contents typically includes a base that extends up to a grip portion suitable for affixing a label, as well as providing a location for grasping the container. The grip portion generally transitions into a shoulder, which connects to a bell. The bell has a diameter that generally decreases as the bell extends upward from the shoulder to a neck and a finish portion. The finish portion is adapted to receive a closure, such as a bottle cap, to seal the contents within the interior of the plastic container.

Advantages of plastic containers include lighter weight and decreased breakage as compared to glass, and lower costs overall when taking both production and transportation into account. As such, there is a continuous interest in creating the lightest possible plastic container so as to maximize cost savings in both transportation and manufacturing by making and using containers that contain less plastic. Embodiments disclosed herein provide container closures that include multiple anchors configured to keep tamper evidence bands coupled with the closures after the closures have been unsealed to access contents within the containers.

### SUMMARY

An apparatus and methods are provided for a container closure for sealing contents within an interior of a container. The container closure comprises a closure portion that is coupled to a tamper evidence band by a plurality of anchors. The closure portion threadably engages with a finish portion of the container and seals contents in the interior of the container. The plurality of anchors are configured to keep the tamper evidence band coupled with the closure portion. A multiplicity of thin connections are arranged at various intervals around the circumference of the tamper evidence band and between adjacent anchors. The multiplicity of thin connections between the tamper evidence band and the closure portion break apart when the closure portion is untightened from the finish portion. The plurality of anchors are configured to remain unbroken and cause the tamper evidence band to remain attached to the closure portion upon being removed from the finish portion. Broken thin connections are configured to provide an observational indication that the closure has been unsealed from the finish portion after having been installed by a manufacturer.

In an exemplary embodiment, a closure for sealing contents within an interior of a container comprises: a closure portion for threadably engaging with a finish portion of the container; a tamper evidence band for engaging with the finish portion; and a plurality of anchors for keeping the closure portion attached to the tamper evidence band.

In another exemplary embodiment, the plurality of anchors comprises at least three anchors disposed around the circumference of the tamper evidence band. In another exemplary embodiment, the at least three anchors are arranged at 120-degree intervals around the circumference of the tamper evidence band at least two thin connections are arranged between adjacent anchors. In another exemplary embodiment, the plurality of anchors comprises three anchors arranged at 90-degree intervals along the circumference of a first half of the tamper evidence band. In another exemplary embodiment, at least three thin connections are disposed along the circumference of a second half of the tamper evidence band and at least one thin connection is disposed between adjacent anchors along the first half of the tamper evidence band. In another exemplary embodiment, the plurality of anchors comprises at least four anchors disposed at uniform intervals around the circumference of the tamper evidence band and at least one thin connection is disposed between adjacent anchors.

In another exemplary embodiment, a multiplicity of thin connections attach the tamper evidence band to the closure portion and are configured to break apart when the closure portion is untightened from the finish portion. In another exemplary embodiment, the tamper evidence band is configured to engage with the finish portion when the closure portion is removed from the container so as to cause the multiplicity of thin connections to break apart. In another exemplary embodiment, the plurality of anchors are configured such that only the multiplicity of thin connections break apart during loosening of the closure portion. In another exemplary embodiment, the plurality of anchors are configured to ensure that the tamper evidence band remains attached to the closure portion upon being removed from the finish portion while broken thin connections allow portions of the tamper evidence band to separate from the closure portion. In another exemplary embodiment, the broken thin connections are configured to provide an observational indication that the closure has been unsealed from the finish portion after having been installed by a manufacturer.

In an exemplary embodiment, a method for a closure to seal contents within an interior of a container comprises: configuring a closure portion for threadably engaging with a finish portion of the container; configuring a tamper evidence band for engaging with the finish portion; and joining the closure portion and the tamper evidence band by way of a plurality of anchors.

In another exemplary embodiment, joining includes configuring the plurality of anchors to keep the closure portion attached to the finish portion after the closure portion is unsealed from the container. In another exemplary embodiment, joining includes coupling the closure portion and the tamper evidence band by way of a multiplicity of thin connections configured to break apart when the closure portion is untightened from the finish portion. In another exemplary embodiment, joining includes configuring the plurality of anchors such that only the multiplicity of thin connections break apart during loosening of the closure portion.

In another exemplary embodiment, joining includes disposing at least three anchors around the circumference of the tamper evidence band. In another exemplary embodiment, disposing includes arranging three anchors at 120-degree intervals around the circumference of the tamper evidence band and at least two thin connections between adjacent anchors. In another exemplary embodiment, disposing includes arranging three anchors at 90-degree intervals along the circumference of a first half of the tamper evidence band. In another exemplary embodiment, arranging includes arranging at least three thin connections along the circumference of a second half of the tamper evidence band and arranging at least one thin connection between adjacent anchors along the first half of the tamper evidence band. In another exemplary embodiment, disposing includes arranging at least four anchors at uniform intervals around the circumference of the tamper evidence band at least one thin connection between adjacent anchors.

### BRIEF DESCRIPTION OF THE DRAWINGS

The drawings refer to embodiments of the present disclosure in which:

FIG. 1 illustrates a side view of an exemplary container suitable for storing liquid contents;

FIG. 2 illustrates a side plan view of an exemplary embodiment of the finish portion that is configured to rotatably engage with a closure to seal contents within the interior of the container;

FIG. 3 illustrates side plan view of an exemplary embodiment of a triple anchor container closure that may be threadably engaged with the finish portion shown in FIG. 2;

FIG. 4 illustrates a midline cross-sectional view of the container closure of FIG. 3;

FIG. 5 is a cross-sectional view of the container closure of FIG. 4, taken along line 5-5, illustrating an exemplary embodiment of an angular arrangement of anchors and thin connections disposed between a closure portion and a tamper evidence band comprising the container closure of FIG. 4;

FIG. 6 illustrates an exemplary embodiment of an angular arrangement of multiple anchors and thin connections that may be disposed between a closure portion and a tamper evidence band comprising a container closure, in accordance with the present disclosure; and

FIG. 7 illustrates an exemplary embodiment of an angular arrangement of asymmetric anchors and thin connections that may be disposed between a closure portion and a tamper evidence band comprising a container closure according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first container,” may be made. However, the specific numeric reference should not be interpreted as a literal sequential order but rather interpreted that the “first container” is different than a “second container.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, plastic containers include lighter weight and decreased breakage as compared to glass, and lower costs overall when taking both production and transportation into account. As such, there is a continuous interest in creating the lightest possible plastic container so as to maximize cost savings in both transportation and manufacturing by making and using containers that contain less plastic. Embodiments disclosed herein provide container closures that include multiple anchors configured to keep tamper evidence bands coupled with closures after being unsealed to access contents within the containers.

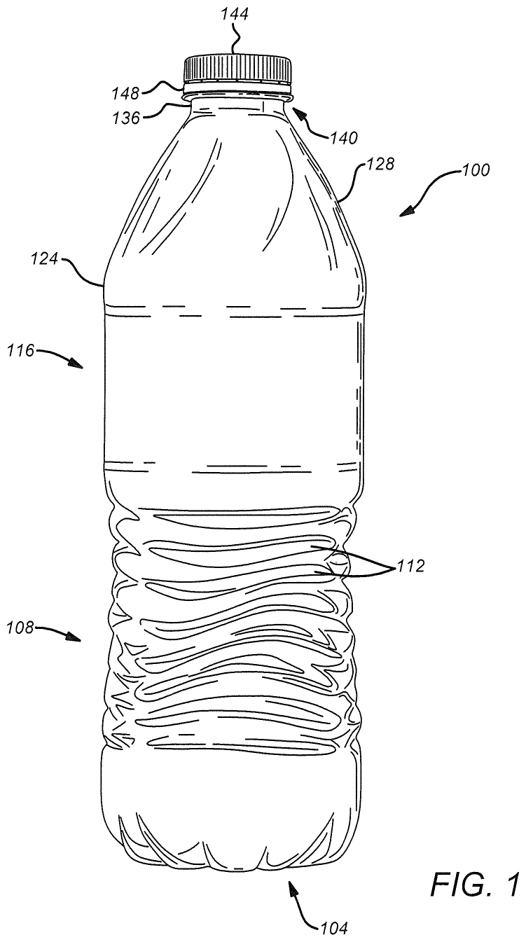

FIG. 1 illustrates a side view of an exemplary container 100 typically used for storing liquid contents, such as water, juice, and contents under pressure. The container 100 comprises a base 104 that extends up to a grip portion 108. In some embodiments, the base 104 may be of the petaloid variety, although other configurations of the base may be incorporated into the container 100, without limitation. The grip portion 108 comprises a plurality of grip portion ribs 112 (i.e., sidewall ribs). As illustrated in FIG. 1, the plurality of grip portion ribs 112 generally vary in depth, and swirl or angulate around the grip portion 108. A label portion 116 is connected to the grip portion 108 and comprises one or more label panel ribs (not shown). The label panel portion 116 transitions into a shoulder 124, which connects to a bell 128.

In the embodiment illustrated in FIG. 1, the bell 128 comprises a plurality of design features 132. In other embodiments, however, the bell 128 may include various other design features, or may be smooth and generally unornamented. The bell 128 connects to a neck 136, which connects to a finish portion 140. As shown in FIG. 1, the bell 128 comprises a diameter that generally decreases as the bell 128 extends upward from the shoulder 124 to the neck 136 and the finish portion 140. The finish portion 140 is adapted to receive a closure, such as by way of non-limiting example, a container cap or closure 144, so as to seal contents within the container 100. The finish portion 140 generally defines an opening that leads to an interior of the container 100 for containing a beverage, or other contents, such as any of a variety of carbonated soft drinks. The finish portion 140 may be of a Carbonated Soft Drink (CSD) variety or may be configured to receive closures suitable for sealing noncarbonated contents within the interior of the container 100. Further, in some embodiments, the finish portion 140 may be configured to retain hot-filled contents with the container or may be configured to retain a gas, such as nitrogen gas (N₂) within the interior of the container, without limitation.

As shown in FIG. 1, a tamper evidence closure 144, such as a bottle cap, may be threadably engaged with the finish portion 140. The closure 144 generally includes interior threads that are configured to engage with threads disposed on the finish portion 140, as described herein. During tightening of the closure 144 onto the finish portion 140, a plug seal of the closure 144 extends into the opening of the container 100 and enters into a pressed relationship with the finish portion 140 whereby contents may be sealed in the interior of the container 100.

With continuing reference to FIG. 1, the closure 144 includes a tamper evidence band 148 to provide an indication of whether or not the closure 144 has been loosened after being installed by a manufacturer. In some embodiments, the tamper evidence band 148 may be attached to the closure 144 by a multiplicity of thin connections. The tamper evidence band 148 may include a cam that is configured to fixedly engage with a tamper evidence ledge disposed on the finish portion 140 during loosening of the closure 144. Once the closure 144 is installed onto the finish portion 140 by a manufacturer and later an end-user loosens the closure 144, the cam engages the tamper evidence ledge, breaking the thin connections between tamper evidence band 148 and the closure 144. The tamper evidence band 148 remains positioned on the tamper evidence ledge after the closure 144 is removed from the container 100. As such, the tamper evidence band 148 cooperates with the tamper evidence ledge to indicate to the end-user whether or not the closure 144 has been previously loosened after being installed by the manufacturer.

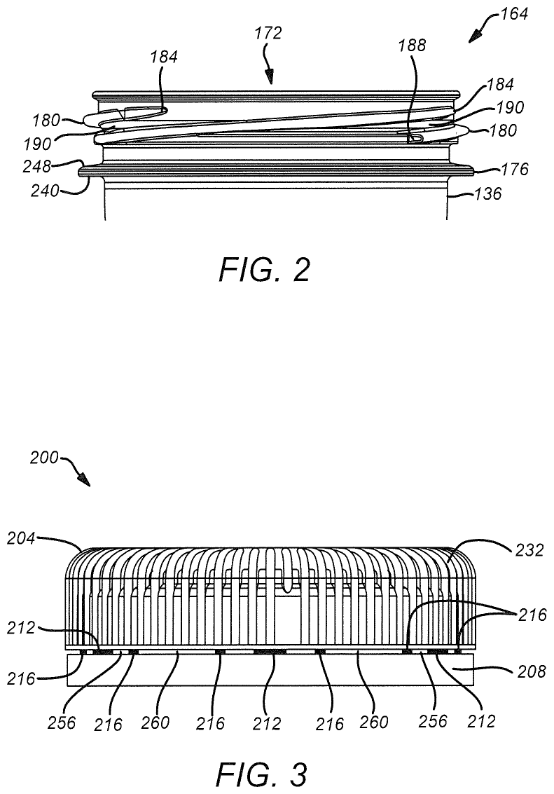

FIG. 2 illustrates a side plan view of an exemplary embodiment of a finish portion 164 that is configured to rotatably engage with the closure 144 so as to seal contents within the interior of the container 100. The finish portion 164 comprises a cylindrical body that begins at an opening 172 to an interior of the container 100 and extends to and includes a tamper evidence ledge 176 that is joined to a neck portion 136 of the container 100. The finish portion 164 is further characterized by the presence of one or more threads 180 configured to provide a means to fasten a closure, such as the closure 144 of FIG. 1, to the container 100. As such, the threads 180 are configured to rotatably engage with similar threads disposed within the closure 144 so as to seal contents within the container 100. In the embodiment illustrated in FIG. 2, each of the threads 180 generally extends along a section of the circumference of the finish portion 164 and approaches the tamper evidence ledge 176. Thus, when the threads of the closure 144 are engaged with the threads 180, and the closure 144 is rotated in a clockwise direction, the closure 144 advances toward the tamper evidence ledge 176.

With continuing reference to FIG. 2, each of the one or more threads 180 begins at a thread start 184 and extends along an angular section of the finish portion 164 to a thread end 188. The thread start 184 is configured to guide a thread comprising the closure 144 into a space, or a valley 190, between adjacent threads 180 so as to threadably engage the closure 144 with the finish portion 164. Further, the threads 180 generally are disposed adjacently to one another, separated by valleys 190, and spaced uniformly around the circumference of the finish portion 164. In some embodiments, wherein three threads 180 are disposed around the finish portion 164, the thread starts 184 of adjacent threads 180 are spaced at substantially 120-degree intervals around the circumference of the finish portion 164. As will be appreciated, however, more or less than three threads 180 may be incorporated into the finish portion 164 without deviating beyond the scope of the present disclosure.

FIG. 3 illustrates an exemplary embodiment of a triple anchor container closure (hereinafter “closure”) 200 that may be threadably engaged with the finish portion 164 shown in FIG. 2. The illustrated embodiment of the closure 200 includes a closure portion 204 that is coupled with a tamper evidence band 208 by way of three anchors 212 and a multiplicity of thin connections 216. Upon the closure portion 204 being removed from the container 100, the thin connections 216 break, allowing the tamper evidence band 208 to partially separate from the closure portion 204 while the anchors 212 keep the tamper evidence band 208 attached to the closure portion 204. In some embodiments, such as the illustrated embodiment of FIG. 3, the anchors 212 are configured to ensure that the tamper evidence band 208 remains attached to the closure portion 204 upon being removed from the finish portion 164 while the broken thin connections 216 allow portions of the tamper evidence band 208 to separate from the closure portion 204. As such, the tamper evidence band 208, once partially separated away from the closure portion 204, provides an observational indication that the closure 200 has been unsealed from the finish portion 164 after having been installed by a manufacturer.

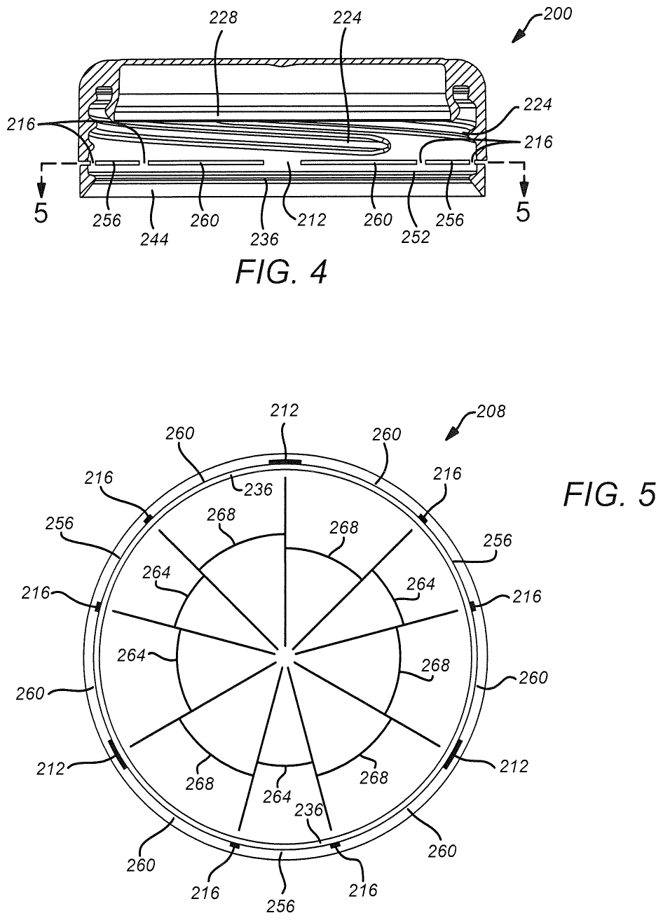

With reference to FIG. 4, the closure 200 is configured to be threadably engaged with the finish portion 164 shown in FIG. 2. The closure 200 includes interior threads 224 that are configured to engage with the threads 180 of the finish portion 164, as described herein. As such, the threads 224 extend into the valleys 190 extending around the finish portion 164. During tightening of the closure 200 onto the finish portion 164, a plug seal 228 of the closure 200 may extend into the opening 172 of the finish portion 164 and enter into a pressed relationship with the finish portion 164 whereby contents may be sealed in the interior of the container 100. As shown in FIG. 3, a plurality of knurls 232 may be arranged on top of the closure portion 204 and configured to facilitate grasping the closure portion 204 during tightening and untightening the closure 200 on the finish portion 164.

As mentioned above, the multiplicity of thin connections 216 may be configured to break apart when the closure portion 204 is untightened from the finish portion 164, such as during opening the container 100 to access contents within the container 100. As shown in FIGS. 4-5, the tamper evidence band 208 includes a cam 236 that interferes with a flat lower portion 240 of the tamper evidence ledge 176 (see FIG. 2). As best shown in FIG. 5, the cam 236 generally comprises a ledge, or a similar structure, that extends around an inner circumference of the tamper evidence band 208 and includes an angled lower surfaces 244 (see FIG. 4) configured to facilitate passing the tamper evidence band 208 over an upper rounded portion 248 (see FIG. 2) of the tamper evidence ledge 176 during installation of the closure 200 onto the container 100. As shown in FIG. 4, the cam 236 includes a relatively flat upper surface 252 that may be configured to interfere with the flat lower surface 240 (see FIG. 2) of the tamper evidence ledge 176 and thus contributes to separating the tamper evidence band 208 and the closure portion 204 during loosening of the closure 200 on the finish portion 164.

As shown in FIGS. 4-5, the anchors 212 generally are larger than the thin connections 216, such that only the thin connections 216 break apart during loosening of the closure portion 204. For example, in some embodiments wherein the closure 200 is formed by way of injection-molding, the anchors 212 may be formed by allowing a greater quantity of the material comprising the closure 200 to fill a greater volume than the volume comprising the thin connections 216. In one exemplary embodiment, a mold for injection-molding the closure 200 may be configured to allow the material comprising the closure 200 to fill one or more spaces 256 (see FIGS. 3-4) between adjacent thin connections 216. As such, one or more protrusions comprising the mold that form the spaces 256 may be omitted in the location of the mold that forms the anchors 212. Further, in some embodiments wherein a knife or other type of blade is used to form the spaces 256 after injection-molding the closure 200, the blade may be configured to avoid cutting the closure 200 at the locations of the anchors 212. It should be understood, therefore, that the anchors 212 may be formed generally by leaving material comprising the closure 200 intact within one or more spaces 256 between the thin connections 216, and thus the anchors 212 may be formed by way of various diverse techniques without limitation, and without deviating beyond the spirit and scope of the present disclosure.

FIG. 5 illustrates an exemplary angular arrangement of the anchors 212 and thin connections 216 that may be utilized between the closure portion 204 and the tamper evidence band 208. In the illustrated embodiment, three anchors 212 are disposed uniformly at 120-degree intervals around the circumference of the tamper evidence band 208. Spaces 260 separate each anchor 212 from adjacent thin connections 216 while the above-mentioned spaces 256 separate adjacent thin connections 216. As shown in FIG. 5, each space 256 corresponds to an angle 264 taken with respect to the center of the tamper evidence band 208. Similarly, an angle 268 corresponds to each space 260. As will be appreciated, therefore, each angle 264 subtends the centers of adjacent thin connections 216, and each angle 268 subtends the centers of an anchor 212 and an adjacent thin connection 216.

It is contemplated that the angles 264, 268 may have any of various suitable values, as is found to be advantageous, without limitation. For example, in one embodiment, each angle 264 is about 30-degrees and each angle 268 is roughly 45-degrees. In some embodiments, however, the angle 256 between each pair of thin connections 216 may be unique, thus positioning the thin connections 216 nonuniformly around the circumference of the tamper evidence band 208. Further, in some embodiments, each of the angles 268 may be unique such that the spacing between the anchors 212 and adjacent thin connections 216 is nonuniform. Further, in some embodiments, the angles 268 each may be smaller than the angles 264, substantially equal to the angles 264, or greater than the angles 264, without limitation.

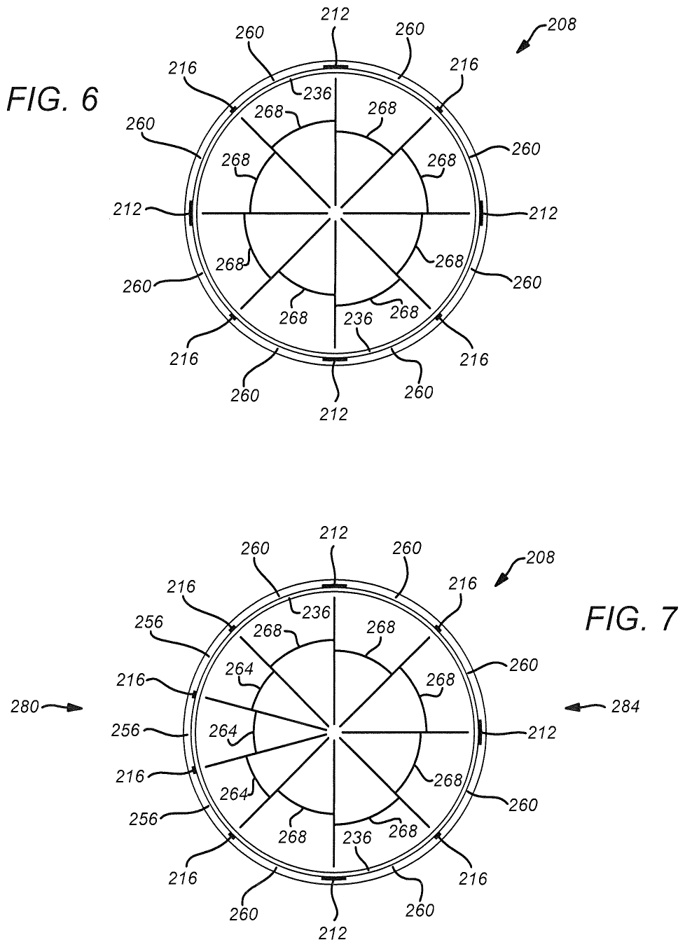

Moreover, the closure 200 is not limited to the number of anchors 212 and thin connections 216 shown in FIG. 5. Rather, in some embodiments, the number of anchors 212 joining the closure portion 204 and the tamper evidence band 208 may be less than or greater the number the of anchors 212 shown in FIG. 5. For example, in an exemplary embodiment illustrated in FIG. 6, four anchors 212 and four thin connections 216 are uniformly arranged around the circumference of the tamper evidence band 208. As such, the four anchors 212 are disposed uniformly at 90-degree intervals around the circumference of the tamper evidence band 208 while an angle 268 comprising about 45-degrees is disposed between the center of each anchor 212 and the centers of neighboring thin connections 216.

As will be appreciated, in the embodiments of FIGS. 5-6, the anchors 212 and thin connections 216 are symmetrically disposed around the circumference of the tamper evidence band 208. It should be understood, however, that in some embodiments, the anchors 212 and thin connections 216 may be arranged asymmetrically around the tamper evidence band 208. In FIG. 7, for example, four thin connections 216 are arranged along a left half 280 of the tamper evidence band 208, whereas three anchors and two thin connections 216 are disposed along a right half 284 of the tamper evidence band 208. As described hereinabove, an angle 264 is disposed between the centers of adjacent thin connections 216 while an angle 268 is disposed between the center of each anchor 212 and the centers of adjacent thin connections 216. Thus, the three anchors 212 are arranged at 90-degree intervals along the right side 284, and each pair of anchors 212 shares one intervening thin connection 216.

It is contemplated that the asymmetric arrangement of anchors 212 and thin connections 216 shown in FIG. 7 will cause a greater separation between the left side 280 of the tamper evidence band 208 and the closure portion 204 when the thin connections 216 break during removing the closure 200 from the container 100 as described herein. The three anchors 212, however, are strong enough to keep the tamper evidence band 208 attached to the closure portion 204, causing the tamper evidence band 208 to detach from the finish portion 164 with the closure portion 204.

It should be borne in mind that the closure 200 is not limited to the number of anchors 212 and thin connections 216 shown in FIGS. 4-7. Rather, in some embodiments, the number of anchors 212 joining the closure portion 204 and the tamper evidence band 208 may be less than or greater the number of anchors 212 shown in FIG. 6. For example, in some embodiments, five or more anchors 212 may be uniformly or nonuniformly disposed around the circumference of the tamper evidence band 208, without limitation. Similarly, the closure 200 is not limited to number of thin connections 216 as shown in the illustrated embodiments of FIG. 4-7. In some embodiments, for example, fewer than six thin connections 216 or more than six thin connections 216 may be incorporated into the closure 200, as desired. Further, the closure 200 is not limited to four or less thin connections 216 disposed between adjacent anchors 212, but rather any number of thin connections 216 may be advantageously arranged between adjacent anchors 212, without limitation.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A closure for sealing contents within an interior of a container, the closure comprising:
a closure portion for threadably engaging with a finish portion of the container;
a tamper evidence band for engaging with the finish portion; and
a plurality of anchors for keeping the closure portion attached to the tamper evidence band.

2. The closure of claim 1, wherein the plurality of anchors comprises at least three anchors disposed around the circumference of the tamper evidence band.

3. The closure of claim 2, wherein the at least three anchors are arranged at 120-degree intervals around the circumference of the tamper evidence band at least two thin connections are arranged between adjacent anchors.

4. The closure of claim 1, wherein the plurality of anchors comprises three anchors arranged at 90-degree intervals along the circumference of a first half of the tamper evidence band.

5. The closure of claim 4, wherein at least three thin connections are disposed along the circumference of a second half of the tamper evidence band and at least one thin connection is disposed between adjacent anchors along the first half of the tamper evidence band.

6. The closure of claim 1, wherein the plurality of anchors comprises at least four anchors disposed at uniform intervals around the circumference of the tamper evidence band and at least one thin connection is disposed between adjacent anchors.

7. The closure of claim 1, wherein a multiplicity of thin connections attach the tamper evidence band to the closure portion and are configured to break apart when the closure portion is untightened from the finish portion.

8. The closure of claim 7, wherein the tamper evidence band is configured to engage with the finish portion when the closure portion is removed from the container so as to cause the multiplicity of thin connections to break apart.

9. The closure of claim 7, wherein the plurality of anchors are configured such that only the multiplicity of thin connections break apart during loosening of the closure portion.

10. The closure of claim 9, wherein the plurality of anchors are configured to ensure that the tamper evidence band remains attached to the closure portion upon being removed from the finish portion while broken thin connections allow portions of the tamper evidence band to separate from the closure portion.

11. The closure of claim 10, wherein the broken thin connections are configured to provide an observational indication that the closure has been unsealed from the finish portion after having been installed by a manufacturer.

12. A method for a closure to seal contents within an interior of a container, comprising:
configuring a closure portion for threadably engaging with a finish portion of the container;
configuring a tamper evidence band for engaging with the finish portion; and
joining the closure portion and the tamper evidence band by way of a plurality of anchors.

13. The method of claim 12, wherein joining includes configuring the plurality of anchors to keep the closure portion attached to the finish portion after the closure portion is unsealed from the container.

14. The method of claim 12, wherein joining includes coupling the closure portion and the tamper evidence band by way of a multiplicity of thin connections configured to break apart when the closure portion is untightened from the finish portion.

15. The method of claim 14, wherein joining includes configuring the plurality of anchors such that only the multiplicity of thin connections break apart during loosening of the closure portion.

16. The method of claim 12, wherein joining includes disposing at least three anchors around the circumference of the tamper evidence band.

17. The method of claim 16, wherein disposing includes arranging three anchors at 120-degree intervals around the circumference of the tamper evidence band and at least two thin connections between adjacent anchors.

18. The method of claim 16, wherein disposing includes arranging three anchors at 90-degree intervals along the circumference of a first half of the tamper evidence band.

19. The method of claim 18, wherein arranging includes arranging at least three thin connections along the circumference of a second half of the tamper evidence band and arranging at least one thin connection between adjacent anchors along the first half of the tamper evidence band.

20. The method of claim 16, wherein disposing includes arranging at least four anchors at uniform intervals around the circumference of the tamper evidence band at least one thin connection between adjacent anchors.
